(19) United States
(12) Patent Application Publication
(10) Pub. No.: US 2002/0196921 A1
(43) Pub. Date: Dec. 26, 2002

(54) Programmable apparatus and method for intercepting incoming phone calls

(76) Inventor: Robert H. Bohl, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/887,852

(22) Filed: Jun. 22, 2001

(51) Int. Cl. H04M 3/42

(52) U.S. Cl. 379/213.01

(57) ABSTRACT

An electrical system for disabling incoming phone calls at selected times and routing calls during these times to a recorded message or an answering machine without ringing the phones in a specific area. This system also allows emergency calls to pass through and ring when normal incoming phone calls have been disabled. The times when calls are disabled may be selected by either pushing a specific button or programming the system through an alphanumeric keyboard.

### FIELD OF THE INVENTION

This invention relates generally to voice messaging and more specifically to disabling incoming phone calls at selected times.

### BACKGROUND OF THE INVENTION

For various reasons, not all phone calls people receive are wanted. Unwanted phone calls are not only a bother to answer and respond to, they disturb the environment where the phone rings. Phone companies can provide options that allow callers to be identified, warn callers that solicitors are not welcome, and take messages. These options and other similar options do not stop the phone from ringing. A device that would allow someone to select specific times when the phone may ring and when it may not ring would be useful. In addition, it is important to allow urgent phone calls to ring though at any time. The apparatus and method described in this invention make it possible to stop the phone from ringing at selected times while at the same time allowing important phone calls to ring through.

### SUMMARY OF THE INVENTION

In a preferred embodiment, the invention disables incoming phone calls at selected times and routes calls during these times to a recorded message or an answering machine without ringing the phone. It also allows emergency calls to pass through and ring when normal incoming phone calls are disabled. The invention comprises a box or part of a phone-answering machine that is physically connected between an incoming phone line and a phone. A programmable apparatus and method for intercepting incoming phone calls embodying the invention makes it easy to select times when no phone calls are wanted while at the same time allowing urgent calls to ring. The invention is easily installed and programmed.

Other aspects and advantages of the present invention will become apparent from the following detailed description, taken in conjunction with the accompanying drawings illustrating by way of example the principles of the invention.

### BRIEF DESCRIPTION OF THE DRAWINGS

FIG. 1 is a block diagram of a phone-call interceptor.

FIG. 2 is a flow chart illustrating an algorithm for the operation of a phone-call interceptor.

### DETAILED DESCRIPTION OF THE PREFERRED EMBODIMENT

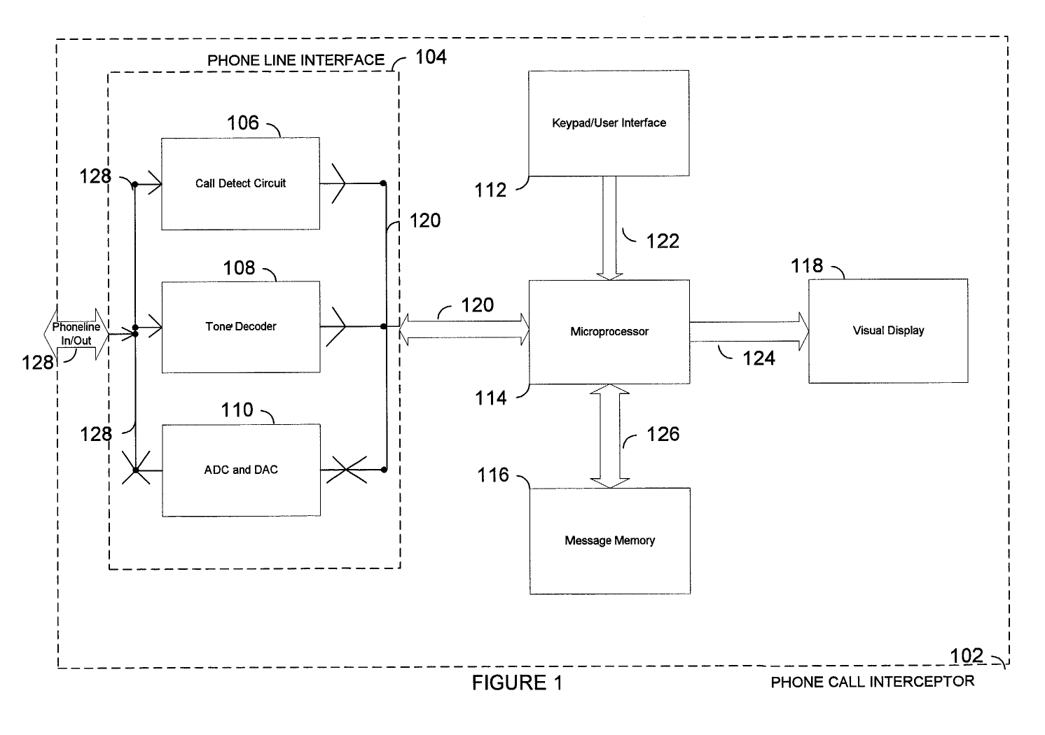

FIG. 1 shows a block diagram of one embodiment of an apparatus for intercepting incoming phone calls. A phone-call interceptor, 102, contains parts that may be used to create a device for intercepting incoming phone calls. These parts may be physically separate electronic parts assembled on a common motherboard or they may be functional descriptions of circuits combined on a single integrated circuit (IC). For example, the phone-line interface, 104 may either be an IC containing a call-detect circuit, 106, a tone-decoder circuit, 108, and an analog-to-digital converter (ADC) and a digital-to-analog converter (DAC) combination circuit, 110 on a single IC or a separate call-detect electronic part, 106, a separate tone-decoder electronic part, 108, and a separate ADC/DAC electronic part, 110 combined to create the function of the phone-line interface, 104. The particular configuration used may be dependent on factors such as cost, ease of manufacture, and reliability.

An incoming/outgoing phone line is connected to a phone-call interceptor at an input, 128, as shown in FIG. 1. The phone line is then electrically connected in parallel to a call-detect circuit, 106, a tone-decoder circuit, 108, and an ADC/DAC circuit, 110 at node 128. A call-detect, 106, circuit is designed to immediately pick up calls to avoid audible ringing of any phones. A tone-decoder circuit, 108, is used to decode tones generated by a person calling in response to a message played for them. For example, the message may ask the caller if this call is an emergency. If the call is an emergency, the caller should press “1”. A tone-decoder circuit, 108, then decodes the tone generated by pressing “1” and sends a signal to a microprocessor, 114, on node 120. A microprocessor, 114, then interprets this signal and allows the call to ring through to the phone.

The ADC/DAC circuit, 110, converts an analog voice signal to a digital format that may be stored in memory, 116. The ADC/DAC also converts digital messages stored in memory, 116, back to an analog voice signal that may be played back through a phone. The phone-line interface, 104, may be an integrated circuit that includes the functions of a call-detect circuit, 106, a tone-decoder circuit, 108, and a ADC/DAC circuit, 110 on a single chip or it may be a circuit that comprises separate electronic components for a call-detect circuit, 106, a tone-decoder circuit, 108, and a ADC/DAC circuit, 110 placed on a PC board. Of course, the incoming message and the prerecorded message may also be stored in the analog domain.

A microprocessor, 114, is used to control the routing of information and executing code generated by other parts of the phone-call interceptor. A microprocessor routes phone messages from an ADC/DAC, 110, to message memory, 116. It also routes messages from message memory to an ADC/DAC, 110 to play back stored messages. Signals sent from a keypad/user-interface, 112, are decoded by a microprocessor, 114, to set time periods when calls are not allowed to ring through. A microprocessor, 114 is also used to send alpha-numeric messages to a visual display. A system clock is included in the microprocessor. The visual display may be a liquid crystal display (LCD), a light emitting diode display (LED display), or some other type of display capable of displaying an alpha-numeric message.

In one embodiment of a phone-call interceptor, the keypad/user interface, 112, shown in FIG. 1 allows a user to select a dedicated button that programs the phone-call interceptor to disable incoming phone calls for 30, 60, 90, or 120 minutes. Also included in this particular embodiment, is the option to program a daily schedule where incoming phone calls are intercepted. For example, the user may program the phone-call interceptor to intercept phone calls between the hours of 10:00 P.M. to 7:00 A.M. everyday of the week. During these times, phone calls are routed to memory storage where the phone message is recorded unless the caller indicated the call was an emergency. Message memory, 116, may be accomplished using any available memory media such as magnetic tape, magnetic discs, hard drives, solid state devices such as DRAMs (dynamic random access memory) or SRAMs (static random access memory), or nonvolatile memory such as EEPROMs (Electrically Erasable Programmable Read Only Memory).

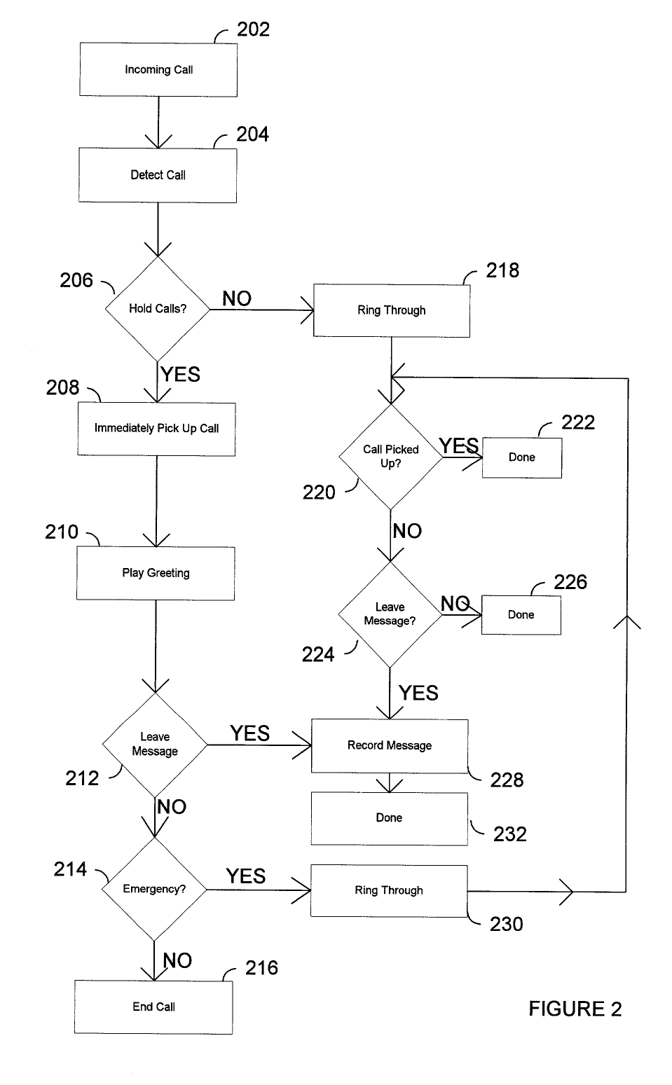

FIG. 2 is a flow chart of an algorithm used to execute a programmable function for intercepting incoming phone calls. In FIG. 2, a step 202 receives an incoming phone call and proceeds to a step 204. In a step 204, a phone call is detected and proceeds to a step 206. In a step 206, the process determines if a call should be held or not. If the device has not been programmed to hold calls, the process proceeds to a step 218. If the device has been programmed to hold calls, the process proceeds to a step 208. In a step 208, the process picks up the call and proceeds to step 210. In a step 210, the process plays a greeting and proceeds to a step 212. In a step 212, the process determines if a message should be left or not. When a message should be left, the process proceeds to a step 228. When a message should not be left, the process proceeds to a step 214. In a step 214, the caller is asked if this call is an emergency. When the call is an emergency, the process proceeds to a step 230. When the call is not an emergency, the process proceeds to a step 216. In a step 216, the process ends the call.

In a step 206, the process determines if a call should be held. When the call should not be held, the process proceeds to a step 218. In a step 218, the call is allowed to ring through and proceeds to a step 220. In a step 220, the process determines if the call is picked up. When the call is picked up, the process proceeds to a step 222. In a step 222, the phone call is answered and the process is finished. When the call is not picked up, the process proceeds to a step 224. In a step 224, the process asks if the caller would like to leave a message. When the caller would like to leave a message, the process proceeds to a step 228. In a step 228, the process records the message and proceeds to a step 232. In a step 232, the process is finished. When the answer to step 224 is no and the caller does not want to leave a message, the process proceeds to a step 226. In a step 226, the process is finished.

In a step 214, when the caller identifies the call as an emergency, the process proceeds to a step 230. In a step 230, the phone rings through and proceeds to a step 220. In a step 220, the process determines if the call is picked up. When the call is picked up, the process proceeds to a step 222. In a step 222, the phone call is answered and the process is finished. When the call is not picked up, the process proceeds to a step 224. In a step 224, the process asks if the caller would like to leave a message. When the caller would like to leave a message, the process proceeds to a step 228. In a step 228, the process records the message and proceeds to a step 232. In a step 232, the process is finished. When the answer to step 224 is no and the caller does not want to leave a message, the process proceeds to a step 226. In a step 226, the process is finished.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1) A method for intercepting incoming phone calls, comprising:
selecting at least one time period; and
disabling at least one phone from ringing during the time period.

2) The method of claim 1, further comprising:
playing a prerecorded message during the selected time period that asks if a caller wants to leave a message;
recording the message from the caller.

3) The method of claim 1, further comprising:
playing a prerecorded message that identifies a tone for the caller to create when the phone call is an emergency;
allowing the phone to ring when the tone is detected.

4) The method of claim 1, the step of setting the time period further comprising:
pushing a button that disables the calls from ringing for a predetermined time.

5) The method of claim 2, the step of setting the time period further comprising:
pushing a button that disables the calls from ringing for a predetermined time.

6) The method of claim 3, the step of setting the time period further comprising:
pushing a button that disables the calls from ringing for a predetermined time.

7) The method of claim 1, the step of setting the time period further comprising:
using an alphanumeric keyboard to program a starting and stopping time for disabling the calls from ringing.

8) The method of claim 2, the step of setting the time period further comprising:
using an alphanumeric keyboard to program a starting and stopping time for disabling the calls from ringing.

9) The method of claim 3, the step of setting the time period further comprising:
using an alphanumeric keyboard to program a starting and stopping time for disabling the calls from ringing.

10) The method of claim 1 further comprising:
displaying all times when the phone is disabled from ringing.

11) The method of claim 2 further comprising:
displaying all times when the phone is disabled from ringing.

12) The method of claim 3 further comprising:
displaying all times when the phone is disabled from ringing.

13) The method of claim 4 further comprising:
displaying all times when the phone is disabled from ringing.

14) The method of claim 5 further comprising:
displaying all times when the phone is disabled from ringing.

15) The method of claim 6 further comprising:
displaying all times when the phone is disabled from ringing.

16) The method of claim 7 further comprising:
displaying all times when the phone is disabled from ringing.

17) The method of claim 8 further comprising:
displaying all times when the phone is disabled from ringing.

18) The method of claim 9 further comprising:
displaying all times when the phone is disabled from ringing.

19) An apparatus for intercepting incoming phone calls and disabling at least one phone from ringing during selected times, comprising:
a call-detect circuit for detecting an incoming phone call with an input and an output, the input connected to a phone line and the output connected to a bus,
a tone-decoder circuit for decoding tones from a caller with an input and an output, the input connected to the phone line and the output connected to the bus;
an ADC/DAC circuit for converting an analog signal to a digital signal and for converting a digital signal to a analog signal with an input and an output, the input connected to the phone line and the output connected to the bus;
a microprocessor connected to the bus, the microprocessor configured to disable the phone output during a selected time period;
a memory for storing prerecorded messages and recording messages, connected to the microprocessor;
an user interface for selecting at least one time when the phone is not allowed to ring, connected to the microprocessor;
a visual display for displaying all times when the phone is disabled from ringing, connected to the microprocessor.

20) The apparatus as in claim 19, further comprising:
the microprocessor that controls a prerecorded message that asks if a caller wants to leave a message;
the memory device for recording the message from the caller.

21) The apparatus as in claim 20, further comprising:
the microprocessor that controls a second prerecorded message that asks if the call is an emergency and allows the phone to ring if the call is an emergency;
the tone-decoder that decodes a tone created by the caller that indicates that the call is an emergency.

22) The apparatus in claim 19, further comprising:
a button to select a least one time when calls are not wanted and disable the phone from ringing during the selected time or times.

23) The apparatus in claim 20, further comprising:
a button to select a least one time when calls are not wanted and disable the phone from ringing during the selected time or times.

24) The apparatus in claim 21, further comprising:
a button to select a least one time when calls are not wanted and disable the phone from ringing during the selected time or times.

25) The apparatus in claim 19, further comprising:
an alphanumeric keyboard to select a least one time when calls are not wanted and disable the phone from ringing during the selected time or times.

26) The apparatus in claim 20, further comprising:
an alphanumeric keyboard to select a least one time when calls are not wanted and disable the phone from ringing during the selected time or times.

27) The apparatus in claim 21, further comprising:
an alphanumeric keyboard to select a least one time when calls are not wanted and disable the phone from ringing during the selected time or times.
